(19) United States
(12) Patent Application Publication
(10) Pub. No.: US 2006/0067025 A1
(43) Pub. Date: Mar. 30, 2006

(54) Solenoid valve control unit

(75) Inventor: Yoshihide Shinso, Zama-shi (JP)

Correspondence Address: BLANK ROME LLP, 600 NEW HAMPSHIRE AVENUE, N.W., WASHINGTON, DC, 20037, US

(73) Assignee: JATCO Ltd., Fuji-shi (JP)

(21) Appl. No.: 11/234,194

(22) Filed: Sep. 26, 2005

(30) Foreign Application Priority Data
Sep. 30, 2004 (JP) 2004-286501

(51) Int. Cl. H01H 47/00

(52) U.S. Cl. 361/160

(57) ABSTRACT

A solenoid valve control unit which applies overexcitation voltage to a solenoid valve coil corresponding to a supply voltage in an overexcitation period occurring during an initial stage of a duty drive “ON” cycle and the solenoid valve control unit applies a holding voltage to the coil lower than the overexcitation voltage in a holding period occurring during the duty drive “ON” cycle other than the initial stage. Subsequently, the control circuit decreases the effective value of the overexcitation voltage by executing a chopper control effect in the overexcitation period.

### BACKGROUND OF THE INVENTION

1. Field of the Invention

The present invention relates to what is termed as a duty solenoid valve control unit.

2. Description of the Related Art

In an automatic transmission of a vehicle, for example, a solenoid valve is used for controlling hydraulic pressure. As such a solenoid valve, a duty solenoid valve (a unit for controlling hydraulic fluid pressure by being duty driven) is known from conventional prior art, for example, as disclosed in Japanese Laid-Open (Kokai) Patent Application No. H11-184542 (1999) titled “SOLENOID DRIVING CONTROLLER.”

Further, as described in the above-mentioned JP H11-184542, this solenoid valve is controlled by applying overexcitation voltage corresponding to the supply voltage (for example, DC output voltage of a vehicle battery, usually about 13V) to the coil in an overexcitation period occurring during the initial stage of a duty drive “ON” period and applies holding voltage lower than the supply voltage (for example, 2˜3V) to the above-mentioned coil in a holding period occurring during the duty drive “ON” period other than the initial stage. This is provided for improving responsiveness while restraining power consumption and low self-generation of heat.

However, in the solenoid valve mentioned above, an internal plunger repeats reciprocating motion in a duty drive cycle (for example, 50 Hz or 60 Hz). Also, this plunger generally impacts (collides) with a thin component called a shim (nonmagnetic material which forms a magnetic gap between the fixed side of the core and the plunger) whenever operated. Consequently, the wear limit of this shim determines the life span of the solenoid valve. Conventionally, a solenoid valve used as a line pressure regulator, etc. in an automatic transmission of a vehicle has a life span of about 150,000˜200,000 km (93,205˜124,274 miles) in vehicle traveling distance (mileage). Solenoid valves need to be replaced whenever the life span approaches. Accordingly, further improvement in this life span is desired.

### SUMMARY OF THE INVENTION

Therefore, the present invention has been made in view of the circumstances mentioned above. Accordingly, the object of the present invention is to provide a solenoid valve control unit capable of realizing a longer life span for a duty solenoid valve which surpasses conventional limitations.

The solenoid drive apparatus of the present invention is a solenoid valve control unit which performs duty drive of a solenoid valve to apply an overexcitation voltage to a solenoid valve coil corresponding to a supply voltage in an overexcitation period occurring during an initial stage of a duty drive “ON” cycle and the solenoid valve control unit applies a holding voltage to the coil lower than the overexcitation voltage in a holding period occurring during the duty drive “ON” cycle other than the initial stage, comprising an overexcitation voltage control means for decreasing an effective value of the overexcitation voltage by executing chopper control in the overexcitation period.

As a preferred embodiment of the present invention, the overexcitation voltage control means executes the chopper control to decrease the effective value of the overexcitation voltage whenever the supply voltage exceeds a previously set reference value.

Also, as a preferred embodiment of the present invention, the overexcitation voltage control means increases a ratio by decreasing a duty factor of the chopper control and decreasing the effective value of the overexcitation voltage to the extent that the supply voltage becomes higher.

Also, as a preferred embodiment of the present invention, the overexcitation voltage control means executes the chopper control to decrease the effective value of the overexcitation voltage whenever the temperature of oil flowing in the solenoid valve exceeds the previously set reference value.

Also, as a preferred embodiment of the present invention, the overexcitation voltage control means increases the ratio by decreasing the duty factor of the chopper control and decreasing the effective value of the overexcitation voltage to the extent that the temperature of oil flowing in the solenoid valve becomes higher.

Also, as a preferred embodiment of the present invention, further comprising an overexcitation period control means for decreasing the overexcitation period corresponding to increasing temperature of oil flowing in the solenoid valve.

According to the present invention, an overexcitation voltage control means decreases the effective value of the overexcitation voltage by executing chopper control in an overexcitation period. Therefore, by the function of this overexcitation voltage control means, the plunger speed can be set as a low value close to the necessary minimum. Thus, abrasion of the component (for example, the shim) is controlled and the life span of a solenoid valve can be significantly extended.

Also, in a conventional prior art solenoid valve control unit, high voltage corresponding to the supply voltage is always applied to the solenoid during an overexcitation period. For this reason, except in cases of a particular condition, such as when the supply voltage (for example, output voltage of a vehicle battery) excessively decreases or when the temperature of the oil flowing in the solenoid valve is extremely low (the oil viscosity is considerably high), etc., the plunger speed during operation of the solenoid valve is always excessive. Thus, wear (abrasion) of the component (for example, the shim) due to impacting with the plunger during operation is equally intense.

On the other hand, in the present invention, the effective value of the overexcitation voltage can be actively reduced to a necessary minimum (voltage close to the solenoid valve minimum operating voltage, for example, about 9V) by the function of the overexcitation voltage control means. Accordingly, also under normal conditions, the plunger speed can be set as a low value close to the necessary minimum. Thus, wear of a component (for example, the shim) due to plunger impact can be significantly controlled.

Also, according to the preferred embodiments, as the configuration of the present invention executes the above-mentioned chopper control when the supply voltage exceeds a previously set reference value, there is the following advantage. Specifically, even when supply voltage is low (in cases where the supply voltage is less than the voltage close to the minimum operating voltage), chopper control is performed and a voltage deficiency in which the solenoid valve doesn't function properly can be avoided.

Also, according to the preferred embodiments, as the configuration of the present invention increases the ratio for decreasing the duty factor (also referred to as duty ratio) of the chopper control and decreasing the effective value of the overexcitation voltage to the extent that the supply voltage becomes higher, there is the following advantage. Specifically, when there is a supply voltage fluctuation, the duty factor of the chopper control is varied so that influence related to a fluctuation of this supply voltage can be negated. Accordingly, the plunger speed can be maintained, for example, at the appropriate constant value. In this manner, while controlling wear of the above-mentioned shim component, the dependability and responsiveness of the solenoid valve operation can be always assured.

Also, according to the preferred embodiments, as the present invention configuration executes the above-mentioned chopper control and decreases the effective value of the overexcitation voltage when the temperature of the oil flowing in the solenoid valve exceeds a previously set reference value, there is the following advantage. Specifically, even when the oil temperature is low (when the voltage applied is not adequately higher than the minimum operating voltage to the point that the solenoid valve doesn't function properly), chopper control is performed and decline in the solenoid valve responsiveness can be avoided.

Also, according to the preferred embodiments, as the present invention configuration increases the ratio for decreasing the duty factor of the chopper control and decreasing the effective value of the overexcitation voltage to the extent that the temperature of the oil flowing in the solenoid valve becomes higher, there is the following advantage. Specifically, when the oil viscosity changes due to fluctuation of the oil temperature, the duty factor of the chopper control is varied so that influence related to this fluctuation can be negated. Accordingly, the plunger speed can be maintained, for example, at the appropriate constant value. Further, while controlling wear of the above-mentioned shim component, the responsiveness of the solenoid valve operation can be always assured.

Also, according to the preferred embodiments, as the present invention configuration varies the above-mentioned overexcitation period in a decreasing direction corresponding to increasing oil temperature flowing in the solenoid valve, there is the following advantage. Specifically, even if the oil temperature varies, the above-mentioned overexcitation period is sustained to the necessary minimum length corresponding to oil temperature variations. Thus, power consumption is always sustainable at a necessary minimum while preventing inadequate suction of the plunger.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1A is a circuit diagram showing the circuit configuration of the solenoid valve control unit in the preferred embodiment of the present invention;

FIG. 1B is a timing chart for explaining operation of the solenoid valve control unit;

FIG. 2A is a timing chart for explaining operation of the solenoid valve control unit in comparison with normal control;

FIG. 2B is a diagram showing the duty factor of the chopper control relative to battery voltage of vehicles;

FIG. 3 is a cross-sectional diagram showing a solenoid valve;

FIG. 4A is a partially enlarged sectional view diagram showing the substantial part of a solenoid valve;

FIG. 4B is a mimetic diagram of a solenoid valve;

FIG. 5A is a circuit diagram showing the circuit configuration of the solenoid valve control unit in the second embodiment;

FIG. 5B is a timing chart f or explaining operation of the solenoid valve control unit; and

FIG. 6 is a flow chart showing the setup processing with regard to overexcitation of the solenoid valve control unit in the third embodiment.

### DETAILED DESCRIPTION OF THE PREFERRED EMBODIMENTS

Hereinafter, the preferred embodiments of the present invention will be described in detail with reference to the drawings.

Additionally, illustration of specific or example numerical values for various details in the following explanation or character strings and other symbols are merely references for a clear understanding of the concept of the present invention. Accordingly, the concept of the present invention should not be limited explicitly to this terminology entirely or in part.

Furthermore, explanation has been omitted which describes details of well-known methods, well-known procedures, well-known architecture, well-known circuit configurations, etc. (hereinafter denoted as “common knowledge”) for the purpose of a concise explanation, but does not intentionally exclude this common knowledge entirely or in part. Therefore, relevant common knowledge already known by persons skilled in the art at the time of filing the present invention is naturally included in the following description.

### First Embodiment

Initially, the first embodiment example will be explained.

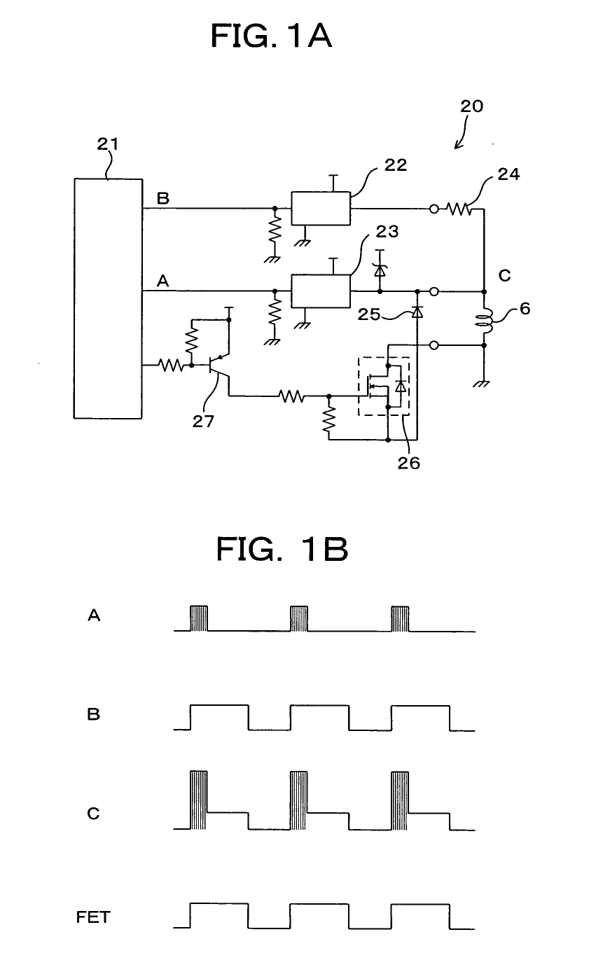

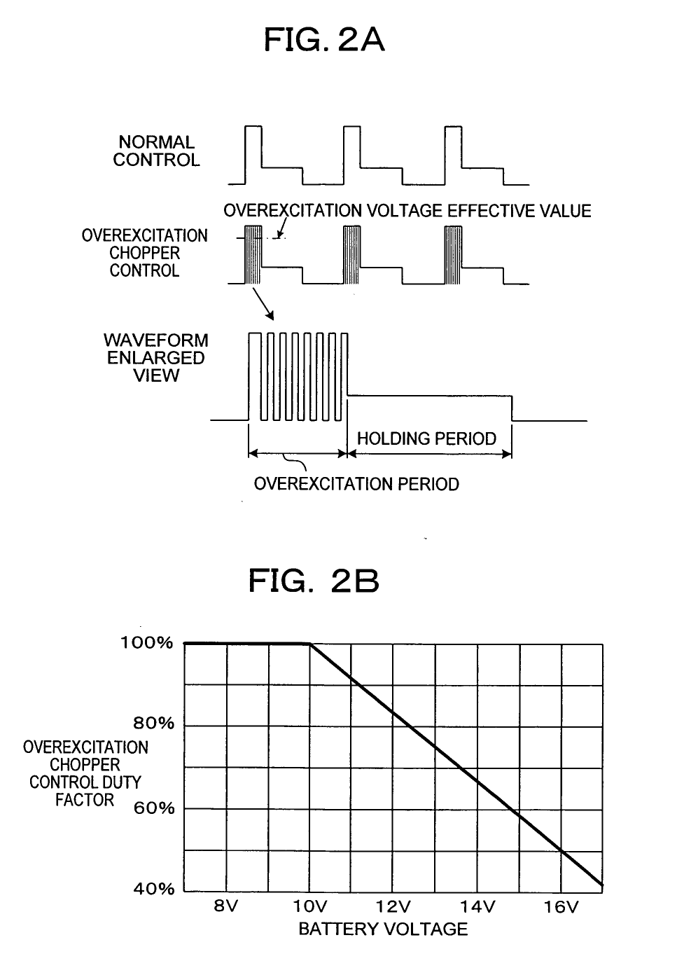

FIG. 1A is a circuit diagram showing the circuit configuration of an example solenoid valve control unit. FIG. 1B is a timing chart for explaining operation of the same control unit. FIG. 2A is a timing chart for explaining operation of the same control unit as compared with control (normal control) of the conventional prior art. FIG. 2B is a diagram showing the duty factor of the chopper control relative to battery voltage (supply voltage) of vehicles.

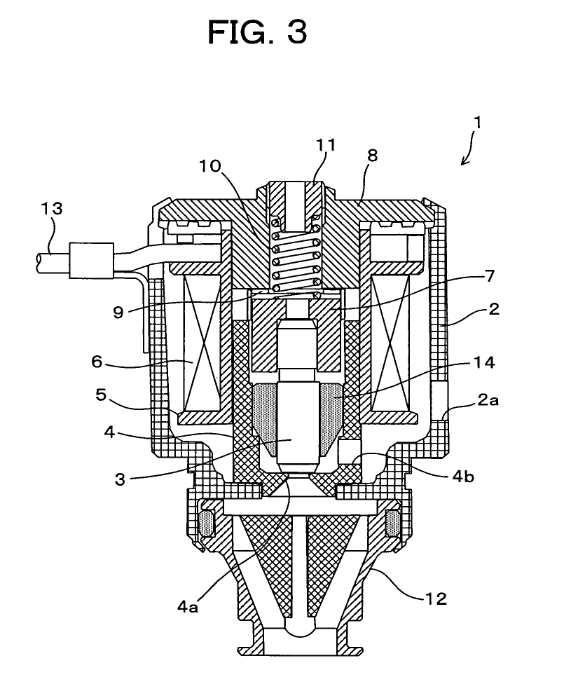

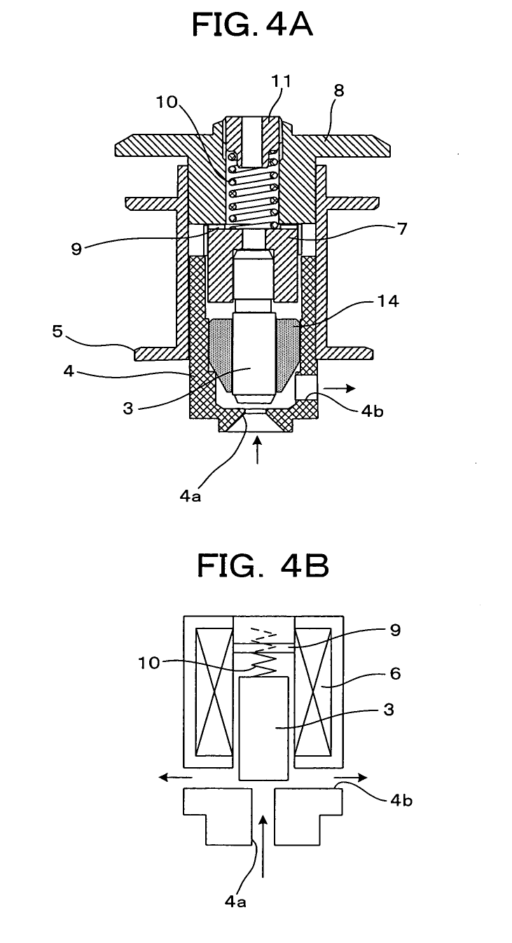

Also, FIG. 3 is a cross-sectional diagram showing a solenoid valve 1 which is an illustrative example of a solenoid valve. FIG. 4A is a partially enlarged sectional view diagram showing the substantial part of a solenoid valve 1. FIG. 4B is a mimetic diagram of a solenoid valve 1. Furthermore, FIG. 3 shows the descending state of a plunger 3 described later. FIG. 4A shows the ascending state of a plunger 3 described later.

First, the structure of the solenoid valve 1 will be explained.

The solenoid valve 1, as seen in FIG. 3, comprises a body 2, a plunger 3, a cylinder 4, a bobbin 5, a coil 6, a movable side core 7, a fixed side core 8, a shim 9, a return spring 10, a spring adjustment screw 11, a member 12 and a lead out cable 13. The body 2 is the housing covering the external surface. The plunger 3 is practicably situated for reciprocating motion upon the central axis line within the inner part of the body 2. The cylinder 4 is coaxial with the plunger 3 and situated on the outer circumference side of the plunger 3. The bobbin 5 is situated on the outer circumference side of the cylinder 4. The coil 6 is wrapped around the outer circumference of the bobbin 5. The movable side core 7 (movable side yoke composed of magnetic material, for example, free-cutting steel, etc.) is fixed to the upper end of the plunger 3. The fixed side core 8 (fixed side yoke composed of magnetic material, for example, free-cutting steel, etc.) is situated on the upper side of the movable side core 7. The shim 9 (laminated component composed of non-magnetic material, for example, stainless steel, etc.) for forming a magnetic gap is situated in the lower surface side of the fixed side core 8. The return spring 10 is arranged within the through-hole formed on the central axis line within the fixed side core 8 and applies downward force to the plunger 3. The spring adjustment screw 11 is screwed into the upper part of a threaded through-hole on the fixed side core 8 and adjusts the strain amount (namely, energized force) of the return spring 10. The member 12 for port connections is mounted on the lower end of the body 2. The lead out cable 13 is for connecting the coil 6 to a circuit of the control unit.

Here, the cylinder 4 is a cylindrical shaped component containing an inflow side port 4a (inlet port) formed in the lower end part and an outflow side port 4b (outlet port) formed in the relatively lower part of a side wall and set in a fixed state to the body 2. The plunger 3 is installed within the cylinder 4 via a sliding bearing 14 for practicable up and down reciprocating motion relative to the cylinder 4 (namely, relative to the body 2). Also, the lower end surface of the plunger 3 constitutes a practicable size and shape which can close the upper surface side of the inflow side port 4a (namely, seal the orifice) when the plunger 3 descends. Furthermore, the return spring 10 is loaded in a state which can be pushed and contracted between the lower surface of the spring adjustment screw 11 and the upper surface of the movable side core 7.

Consequently, normally (when the oil temperature, etc. is an appropriate range) in a non-operating state, voltage more than the minimum operating voltage is not applied to the coil 6. Thus, the plunger 3 moves in the direction (in this case, downwards) which closes the inflow side port 4a according to the energized force of the return spring 10. Then, when voltage more than the minimum operating voltage is applied to the coil 6, the electromagnetic induction force composed of the coil 6, the moveable side core 7 and the fixed side core 8 will exceed the energized force of the return spring 10. Thus, the plunger 3 moves in the direction (in this case, upwards) which opens the inflow side port 4a and becomes in a state (position where the shim 9 is between the movable side core 7 and the fixed side core 8) where the moveable side core 7 impacts and unites with the shim 9.

In this manner, while performing duty drive with the solenoid valve 1, the internal part of the plunger 3 repeats reciprocating motion (in the case of FIG. 3 and FIG. 4A, reciprocating movement) by a duty drive cycle (for example, 50 Hz or 60 Hz) and impacts with the shim 9 whenever the plunger 3 is drawn in by the electromagnetic force. For this reason, the wear limit of this shim 9 determines the life span of the solenoid valve 1. Naturally, it is possible to consider extending the life span by increasing the thickness of the shim 9. However, in order to form an appropriate magnetic gap, the thickness of the shim 9 can hardly be increased so life span cannot be substantially increased very much only by this countermeasure.

Besides, the shown example of the solenoid valve is used as a line pressure regulator, etc. of an automatic transmission for a vehicle. The pressure of a hydraulic circuit (circuit line which supplies the source pressure of a hydraulic pump (not shown)) can be regulated within the limits of the source pressure and is connected to the inflow side port 4a via the member 12 used for port connections. When the plunger 3 is ascending and the inflow side port 4a is open, some of the oil from the above-mentioned hydraulic circuit will flow out of the inflow side port 4a into the outflow side port 4b as shown by the arrows in FIG. 4A and discharged outside of the hydraulic circuit from a drain hole 2a (shown in FIG. 3) provided in the body 2. For this reason, when the operation ratio (namely, the duty factor of the duty drive) of the plunger 3 being drawn in is varied, the pressure (namely, the pressure of the above-mentioned hydraulic circuit) of the inflow side port 4awill correspondingly vary.

Next, the configuration of the solenoid valve control unit 20 will be explained.

The solenoid valve control unit 20 example, as seen in FIG. 1A, is a dropping register method apparatus comprising a control circuit 21 composed of a microcomputer, intelligent power devices 22, 23, a dropping resister 24, a flywheel diode 25 and a FET 26 (Field-Effect Transistor) (electrolysis effect type transistor). Also, the control circuit 21 configuration contains an overexcitation voltage control means of the present invention.

Here, when an “ON” control signal (signal of the signal line shown in FIG. 1A with the letters “A” and “B”) is inputted from the control circuit 21, the intelligent power devices 22, 23 will output voltage (supply voltage) corresponding to supply voltage (for example, output voltage for a vehicle battery of about 8˜16V). Between these two devices, the intelligent power device 23 is for providing a direct connection of the output terminal to the high potential side terminal of the coil 6 and applying high voltage (overexcitation voltage) to the high potential side terminal of the coil 6 in an overexcitation period. On the other hand, the intelligent power device 22 is for providing a connection of the output terminal to the high potential side terminal of the coil 6 via the dropping register 24 and applying low voltage (holding voltage, for example, 2˜3V) to the high potential terminal of the coil 6 in a holding period.

In addition, the dropping resistor 24 is resistance connected between the output terminal of the intelligent power device 22 and the high potential terminal of the coil 6. Furthermore, the applied voltage of a holding period (holding voltage lower than overexcitation voltage) is generated by means of the voltage drop due to this resistance.

Also, the flywheel diode 25 is a diode connected in parallel to the coil 6 and is for absorbing counterelectromotive force (CEMF) generated when the applied voltage of the coil 6 is turned “OFF.”

In addition, the FET 26 is a transistor connected in series to the flywheel diode 25 and in parallel relative to the coil 6. Further, the FET 26 is controlled by the control circuit 21 via a transistor 27.

Next, the control circuit 21 configuration controls the intelligent power devices 22, 23 and the FET 26 as seen in FIGS. 1B and 2A. First, in regard to the signal (control signal of the intelligent power device 23) of the signal line “A”, chopper control is executed by switching “ON” and “OFF”, for example, in 2 Khz cycles during an overexcitation period and control maintained as “OFF” in a holding period. Besides, in regard to the signal (control signal of the intelligent power device 22) of the signal line “B”, control is executed by simply switching “ON” in a duty control “ON” period inclusive of an overexcitation period and a holding period. In addition, the cycle of this duty control (control for performing duty drive of the solenoid valve 1) is, for example, 50 Hz or 60 Hz.

The above-mentioned chopper control is for decreasing the effective value (commonly referred to as the root-mean-square (RMS) value descriptive of the mathematical process used to calculate the effective value) of the overexcitation voltage more than the voltage corresponding to the supply voltage. Furthermore, the duty factor (also known as duty ratio) is set corresponding to the supply voltage based on a graph (relationship of the battery voltage and the duty factor which are supply voltage) as shown for example in FIG. 2B. In the case of FIG. 2B, the duty factor of 100% is performed to supply voltage that is less than a previously set reference value (10V) and the above-mentioned chopper control is essentially not executed (namely, constitutes same as conventional normal control). Then, when the supply voltage exceeds a reference value (10V), the above-mentioned chopper control is executed and the above-mentioned duty factor of the chopper control decreases to the extent that the supply voltage becomes higher. In this case, the duty factor of the supply voltage and the chopper control has a relationship of inverse proportion in the range where the supply voltage exceeds a reference value (10V). Thus, with the supply voltage at 16V, the above-mentioned duty factor of the chopper control is set to 50%.

In addition, although the battery voltage which represents the supply voltage of a vehicle is normally maintained at about 13.5V, this level fluctuates according to the charge state, etc. Besides, in the case of a relationship as shown in FIG. 2B in contrast to supply voltage 13.5V, the effective value of the coil 6 applied voltage (overexcitation voltage) becomes about 9V due to the above-mentioned chopper control.

Furthermore, as the above-mentioned chopper control is technically synonymous with duty control, in order to distinguish the solenoid valve 1 from duty control which performs duty drive, here this reference will be stated as chopper control.

Moreover, in the above-mentioned chopper control, for example as shown in the lower section of FIG. 2A, only the initial first cycle of an overexcitation period is performed at a duty factor of 100% regardless of the supply voltage to enhance the functional reliability and responsiveness of the solenoid valve 1.

Next, the control circuit 21 which controls the FET 26 as shown at the lower section of FIG. 1B will be explained. Specifically, the FET 26 is switched “ON” in a duty control “ON” period inclusive of an overexcitation period and a holding period, which in turn executes a controlling effect to the flywheel diode 25. Also, in the above-mentioned duty control “OFF” period, the FET 26 is switched “OFF” and the flywheel diode 25 is overridden in order to enhance functional responsiveness of the solenoid valve 1.

As the control unit 21 explained above, the voltage (voltage of the coil 6 high potential side terminal shown with the letter “C” in FIG. 1A) applied to the coil 6 of the solenoid valve 1 constitutes a waveform as seen in the third row “C” of FIG. 1B and the second and third rows of FIG. 2A. The effective value of the applied voltage (overexcitation voltage) in an overexcitation period is adjusted to a value normally lower than the supply voltage by the above-mentioned chopper control.

For this reason, the plunger 3 speed during operation of the solenoid valve 1 (reciprocation of the plunger 3) is always maintained at a necessary minimum low value. Accordingly, wear (abrasion) of the shim 9 is controlled and the life span of the solenoid valve 1 can be significantly extended.

Besides, in a conventional prior art solenoid valve control unit, as shown in the first row of FIG. 2A during an overexcitation period, high voltage corresponding to the supply voltage is always applied to the solenoid. Therefore, except in cases of a particular condition, such as when the supply voltage decreases (for example, the battery voltage of a vehicle) or when the temperature of the oil flowing in the solenoid valve is extremely low (the oil viscosity is considerably high), the plunger speed during operation of the solenoid valve is always excessive. Thus, wear of a component (for example, the shim 9) due to impacting the plunger during operation is equally intense.

However, according to this example, the effective value of the overexcitation voltage can be actively reduced to a necessary minimum value (voltage close to the solenoid valve minimum operating voltage, for example, about 9V) by the above-mentioned chopper control. Accordingly, also under normal conditions, the plunger speed can be set as a value close to the necessary minimum. In this manner, wear of the shim 9 can be significantly controlled.

Furthermore, the subsequent results are based on experiments by the inventor in the case of a valve (mechanism used as a line pressure regulator, etc. of an automatic transmission for a vehicle) such as the solenoid valve 1 mentioned above. When overexcitation voltage is applied at 13.5V, the plunger speed is 1 ms (millisecond). However, when overexcitation voltage is applied at 9V, the plunger speed distinctly decreases to about 0.6˜0.7 ms. Then, assuming that the wear limit of the shim 9 (life span of a solenoid valve) is determined by impact energy and volume of the impact frequency (number of times) of the plunger, by decreasing the plunger speed to about 0.6˜0.7 ms indicates that this life span can be extended to about 400,000 km in vehicle traveling distance (mileage).

In this example (control example shown in FIG. 2B), because the configuration executes the above-mentioned chopper control only when the supply voltage exceeds a previously set reference value 10V, there is the following advantage. Specifically, even when supply voltage is low (in cases where the supply voltage is less than the voltage close to the minimum operating voltage), the above-described chopper control is performed and a decrease in responsiveness due to a voltage deficiency in the solenoid valve 1 can be avoided.

In this example (control example shown in FIG. 2B), because the configuration decreases the duty factor of the chopper control and decreases the effective value of the overexcitation voltage to the extent that the supply voltage becomes higher, there is the following advantage. Specifically, when there is a supply voltage fluctuation, the duty factor of the chopper control is varied so that influence related to a fluctuation of this supply voltage can be negated. Accordingly, the plunger speed can be maintained, for example, at the appropriate constant value. In this manner, while controlling wear of the above-mentioned shim 9, the responsiveness of the solenoid valve operation can be always assured.

### Second Embodiment

Next, the second embodiment of the present invention will be explained.

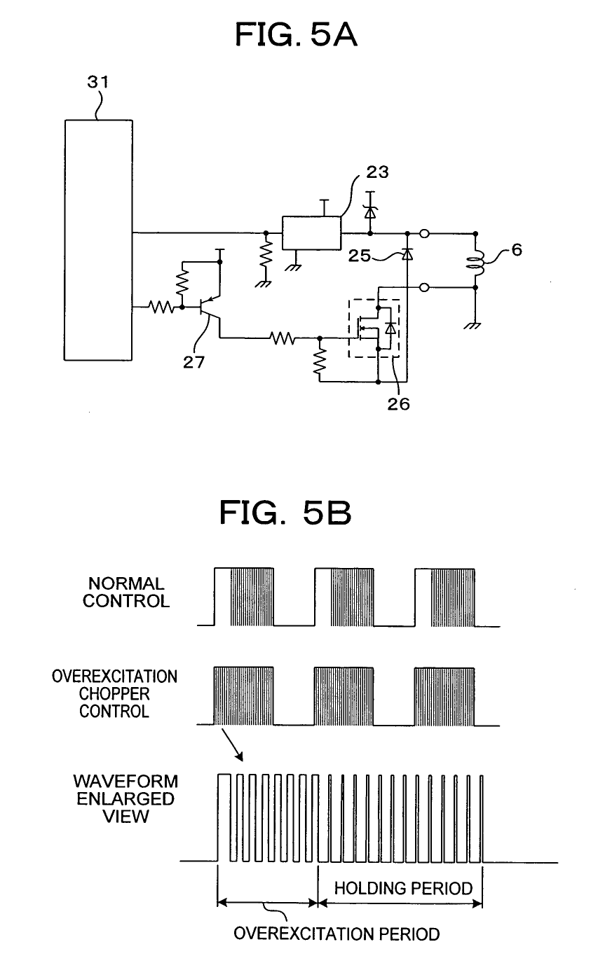

FIG. 5A is a circuit diagram showing the circuit configuration of the solenoid valve control unit in the second embodiment. FIG. 5B is a timing chart for explaining operation of the solenoid valve control unit. Here, because the solenoid control valve configuration is the same as the first embodiment, explanation is omitted. Also, in regard to the same constituent elements of the control unit for the first embodiment, explanation coincides with the equivalent nomenclature and is omitted.

As seen in FIG. 5A, the control unit of the second embodiment is a type which generates holding voltage by chopper control. Further, in comparison with the configuration of the first embodiment (refer to FIG. 1A), the dropping resistor 24 and the intelligent power device 22 have been eliminated.

Also, the example control unit is comprised with a control circuit 31 which has the following control functions.

Specifically, the control signal of the intelligent power device 23 in the control circuit 31 executes chopper control (for example, chopper control in the duty factor shown in FIG. 2B) for applying the same overexcitation voltage as the first preferred embodiment to the coil 6 in an overexcitation period and chopper control for applying holding voltage (2˜3V) in a holding period.

In the control unit as explained above, the voltage applied to the coil 6 of the solenoid valve 1 constitutes a waveform as seen in the second row and the third row of FIG. 5B. The effective value of the applied voltage (overexcitation voltage) in an overexcitation period is adjusted to a value normally lower than the supply voltage by the above-mentioned chopper control. For this reason, the same effect as the first embodiment can also be acquired with this example.

Also, a conventional prior art configuration is known which performs chopper control in a holding period and generates holding voltage; however, in this case chopper control is not performed in an overexcitation period. Thus, the unit is controlled as shown in the first row of FIG. 5B and executed as normal control. In comparison with this, the first embodiment executes chopper control, for example, in 2 Khz cycles, in both an overexcitation period and a holding period. The duty factor of the chopper control in an overexcitation period is set based, for example, on the graph shown in FIG. 2B, and the duty factor of the chopper control in a holding period is set as a value which generates holding voltage.

Furthermore, with regard to the duty factor of the chopper control in a holding period, it is also effective as an embodiment to maintain the holding voltage at an optimally constant value as much as possible and designed to vary corresponding to the supply voltage.

### Third Embodiment

Next, the third embodiment of the present invention will be explained.

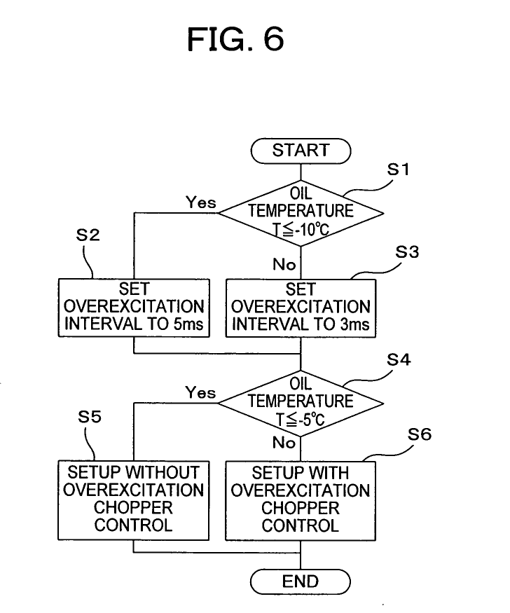

FIG. 6 is a flow chart showing the setup processing with regard to overexcitation in this example of the solenoid valve control unit. Also, this example contains the characteristic control functions regarding overexcitation. Since the remaining configuration is the same as the first embodiment or the second embodiment, explanation except for those characterizing portions is omitted.

In this example control unit, the control circuit 21 or 31 has the capability to execute the setup processing shown in FIG. 6. This processing is explained below.

Initially, in Step S1, the operation judges whether or not the temperature of the oil (oil temperature T) flowing in the solenoid valve 1 is less than a previously set reference value (for example, −10° C. (18° F.)). If less than a reference value, the operation advances to Step S2. Conversely, when exceeding a reference value, the operation advances to Step S3.

Then, at Step S2 an overexcitation time interval (duration of an overexcitation period) is set to 5 ms. At Step S3, an overexcitation time interval is set to 3 ms.

When Steps S2, S3 are accomplished, the operation advances to Step S4 and judges whether or not the oil temperature T is less than a previously set second reference value (for example, −5° C. (27° F.)). If less than second reference value, the operation advances to Step S5. Conversely, when exceeding a reference value, the operation advances to Step S6.

Besides, at Step S5, a setup is executed which does not perform chopper control in an overexcitation period regardless of the supply voltage. At Step S6, a setup is executed which does perform chopper control in an overexcitation period corresponding to the supply voltage. Specifically, at Step S5, the operation always sets the duty factor to 100% of the graph, for example, as shown in the chopper control graph in FIG. 2B. At Step S6, the operation sets according to the graph shown, for example, in FIG. 2B.

Then, when the Steps S5, S6 are accomplished, the sequence of processes will be concluded.

Furthermore, the above-mentioned Step S1˜S6 processes are executed according to the circumstances in a predetermined cycle (for example, sampling cycle of the oil temperature).

Moreover, at Steps S1˜S3, even though the overexcitation time intervals are a two step variation corresponding to the oil temperature T, it is also effective as an embodiment to have multistep overexcitation time intervals corresponding to increases in oil temperature T or made to decrease continuously.

Also, at Steps S4˜S6, although the operation determines whether or not to execute and switch over chopper control in an overexcitation period due to the oil temperature, the above-mentioned chopper control graph is varied minutely corresponding to increases of the oil temperature T. It is also effective as an embodiment to have a multistep duty factor in a decreasing direction relative to the equivalent supply voltage to the extent that the oil temperature becomes higher or made to vary continuously.

In this example, because the configuration executes chopper control in an overexcitation period and decreases the effective value of the overexcitation voltage only when the temperature T of the oil flowing in the solenoid valve exceeds a previously set reference value (for example, −5° C.), there is the following advantage. Specifically, chopper control is performed until the oil temperature T is low with the oil viscosity high (when the voltage applied is not adequately higher than the minimum operating voltage to the point that the solenoid valve doesn't function properly). As a result, a decrease in responsiveness due to a voltage deficiency in the solenoid valve 1 can be avoided.

Also, at low temperature, as viscosity of the oil becomes higher, the plunger becomes more difficult to draw in. Thus, when chopper control in an overexcitation period is performed, the plunger suction force declines excessively and becomes unable to realize predetermined operation of the solenoid valve 1. Also, in such a case, since the impact speed of the plunger is decreased, the chopper control in an overexcitation period for the purpose of a longer life span is unnecessary. Because the above-mentioned chopper control is not executed in the example and under such conditions, the effect mentioned above is achievable.

In the example, because the configuration decreases an overexcitation period corresponding to increasing oil temperature T flowing in the solenoid valve, there is the following advantage. Specifically, also when there is an oil temperature variation, an overexcitation period is maintained at the necessary minimum duration corresponding to the oil temperature variation. Thus, power consumption is always sustainable at a necessary minimum while preventing inadequate suction of the plunger.

Also, in the case of the embodiment, because the ratio is increased by decreasing the duty factor of the chopper control and decreasing the effective value of the overexcitation voltage to the extent that the temperature T of the oil flowing in the solenoid valve becomes higher, there is the following advantage. Specifically, when the oil viscosity changes due to fluctuation of the oil temperature, the duty factor of the chopper control is varied so that influence related to this fluctuation can be negated. Accordingly, the plunger speed can be maintained, for example, at the appropriate constant value. Further, while constantly controlling wear of the above-mentioned shim 9, the responsiveness of the solenoid valve operation can be always assured.

In addition, there may be various modifications and adaptations as the present invention is not restricted to the configuration example mentioned above.

For instance, in the above-mentioned configuration example, the oil temperature reference values and voltages are just one illustrative case. Therefore, it is emphasized that the apparatus should be set according to the circumstances relating to the oil, power source specifications, etc.

Also, in the above-mentioned configuration example, even though in the control circuit 21 the FET 26 is used, the present invention is not limited to this and can be effective with another type of driver element.

While the present invention has been described with reference to the preferred embodiments, it is intended that the invention be not limited by any of the details of the description therein but includes all the embodiments which fall within the scope of the appended claims.

What is claimed is:

1. A solenoid valve control unit which performs duty drive of a solenoid valve to apply an overexcitation voltage to a solenoid valve coil corresponding to a supply voltage in an overexcitation period occurring during an initial stage of a duty drive “ON” cycle and the solenoid valve control unit applies a holding voltage to the coil lower than the overexcitation voltage in a holding period occurring during the duty drive “ON” cycle other than the initial stage, comprising:
an overexcitation voltage control means for decreasing an effective value of the overexcitation voltage by executing chopper control in the overexcitation period.

2. The solenoid valve control unit according to claim 1, wherein said overexcitation voltage control means executes said chopper control to decrease said effective value of said overexcitation voltage whenever the supply voltage exceeds a previously set reference value.

3. The solenoid valve control unit according to claim 1, wherein said overexcitation voltage control means increases a ratio by decreasing a duty factor of said chopper control and decreasing said effective value of said overexcitation voltage to the extent that the supply voltage becomes higher.

4. The solenoid valve control unit according to claim 1, wherein said overexcitation voltage control means executes said chopper control to decrease said effective value of said overexcitation voltage whenever the temperature of oil flowing in the solenoid valve exceeds said previously set reference value.

5. The solenoid valve control unit according to claim 1, wherein said overexcitation voltage control means increases said ratio by decreasing said duty factor of said chopper control and decreasing said effective value of said overexcitation voltage to the extent that the temperature of oil flowing in the solenoid valve becomes higher.

6. The solenoid valve control unit according to claim 1, further comprising an overexcitation period control means for decreasing the overexcitation period corresponding to increasing temperature of oil flowing in the solenoid valve.
